(19) United States
(12) Patent Application Publication
(10) Pub. No.: US 2026/0043751 A1
(43) Pub. Date: Feb. 12, 2026

(54) INSPECTION DEVICE AND MICROPROBE USED THEREIN

(71) Applicant: SAMSUNG ELECTRONICS CO., LTD., Suwon-si (KR)

(72) Inventors: SUNHONG JUN, Suwon-si (KR); Inkeun Baek, Suwon-si (KR); Taejoong Kim, Suwon-si (KR); Younghoon Sohn, Suwon-si (KR)

(73) Assignee: SAMSUNG ELECTRONICS CO., LTD., Suwon-si (KR)

(21) Appl. No.: 19/267,053

(22) Filed: Jul. 11, 2025

(30) Foreign Application Priority Data
Aug. 7, 2024 (KR) 10-2024-0105123

(51) Int. Cl. G01N 21/95; G01N 21/3563; G01N 21/3581

(52) U.S. Cl. CPC G01N 21/9501; G01N 21/3563; G01N 21/3581; G01N 2021/3568

(57) ABSTRACT

Provided is an inspection device including: a light source generating and outputting a femtosecond laser beam; a beam splitter configured to split the femtosecond laser beam into a first light and a second light; a first optical array configured to separate the first light into a first sub-light and a second sub-light and to provide the first and the second sub-lights to an inspection target, wherein the first sub-light and the second sub-light are polarized in different directions; a microprobe configured to detect a photoelectric signal caused by incidence of the first and the second sub-lights on the inspection target, the microprobe including a first microprobe configured to detect the first sub-light and a second microprobe configured to detect the second sub-light; and a second optical array configured to provide the second light to the microprobe.

### CROSS-REFERENCE TO RELATED APPLICATIONS

This U.S. non-provisional patent application claims priority to Korean Patent Application No. 10-2024-0105123, filed on Aug. 7, 2024, the contents of which are hereby incorporated by reference in its entirety.

### BACKGROUND

### 1. Field

The present disclosure relates to an inspection device for a wafer, and more particularly, to a terahertz signal-based inspection device and a microprobe used therein.

### 2. Description of Related Art

Measurement and analysis techniques based on near-field terahertz (THz) spectroscopy have the advantage of being used on patterned wafers in mass production in a non-contact/non-destructive manner. However, since the near-field THz spectroscopy measures transmitted terahertz waves, signal differences occur not only due to a top layer formed by a current process, but also due to a lower layer formed by previous processes. To overcome this, there is a method of measuring terahertz waves before and after each process. However, this approach makes the process more complex and time-consuming as the number of measurements increases.

### SUMMARY

Provided is a terahertz signal-based inspection device capable of simplifying an inspection process and reducing time required for the inspection.

According to an aspect of the disclosure, an inspection device includes: a light source generating and outputting a femtosecond laser beam; a beam splitter configured to split the femtosecond laser beam into a first light and a second light; a first optical array configured to separate the first light into a first sub-light and a second sub-light and to provide the first and the second sub-lights to an inspection target, wherein the first sub-light and the second sub-light are polarized in different directions; a microprobe configured to detect a photoelectric signal caused by incidence of the first and the second sub-lights on the inspection target, the microprobe comprising a first microprobe configured to detect the first sub-light and a second microprobe configured to detect the second sub-light; and a second optical array configured to provide the second light to the microprobe.

According to an aspect of the disclosure, a microprobe for an inspection device includes: a first microprobe configured to detect vertically polarized terahertz light; and a second microprobe configured to detect horizontally polarized terahertz light, wherein the first microprobe and the second microprobe intersect with each other.

### BRIEF DESCRIPTION OF THE DRAWINGS

The above and other aspects and features of certain embodiments of the present disclosure will become apparent from the following description taken in conjunction with the accompanying drawings, in which:

FIG. 1 is a block diagram illustrating a terahertz signal-based inspection device according to one or more embodiments of the present disclosure;

FIGS. 2A and 2B are a conceptual view and an enlarged view illustrating the inspection device of FIG. 1;

FIG. 3 is a conceptual view illustrating a light modulator of an inspection device according to one or more embodiments of the present disclosure;

FIG. 4 is a perspective view illustrating a microprobe according to one or more embodiments of the present disclosure;

FIGS. 5A and 5B are plan views illustrating probe tips of first and second microprobes, respectively;

FIG. 6 is a block diagram illustrating a connection relationship between a controller and other components in an inspection device according to one or more embodiments of the present disclosure; and

FIG. 7 is a view schematically illustrating a principle of wafer inspection using an inspection device according to one or more embodiments of the present disclosure.

### DETAILED DESCRIPTION

Hereinafter, embodiments of the present disclosure will be described with reference to accompanying drawings.

In the following description, like reference numerals refer to like elements throughout the specification.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The present disclosure relates to an inspection device that is able to measure the interior of a semiconductor device in a non-contact manner during a manufacturing process of the semiconductor device. The inspection device may be a terahertz signal-based inspection device.

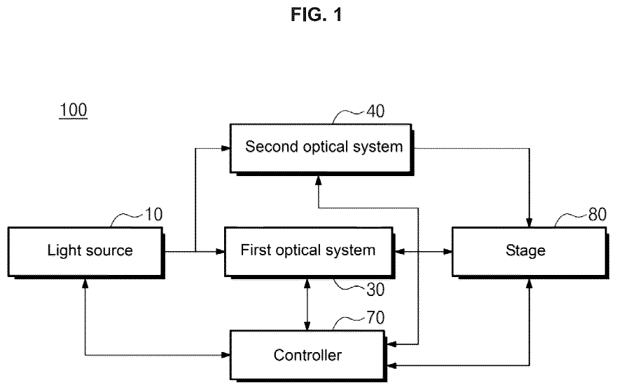

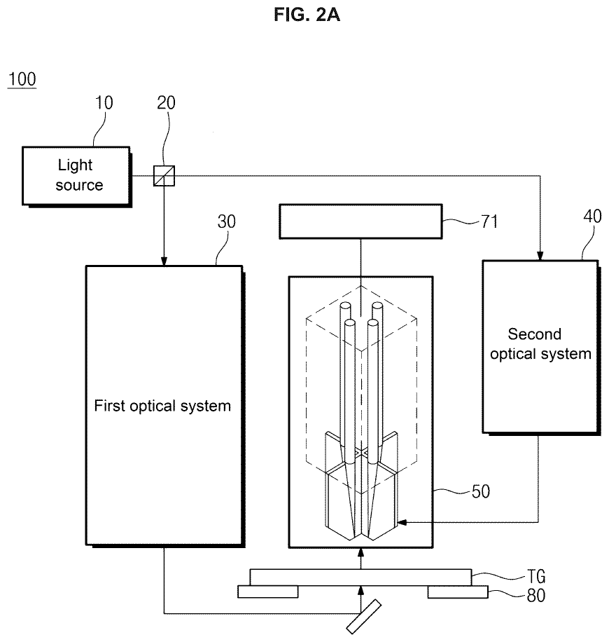

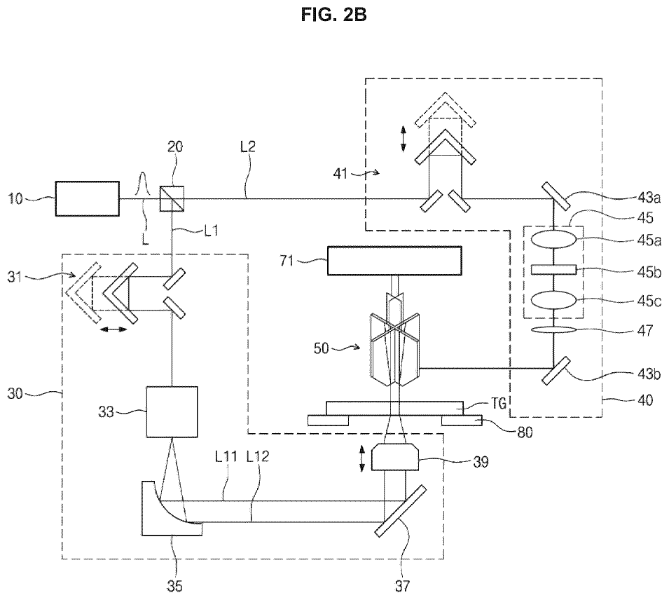

FIG. 1 is a block diagram illustrating the terahertz signal-based inspection device 100 according to one or more embodiments of the present disclosure. FIG. 2A is a conceptual view schematically illustrating the inspection device of FIG. 1, and FIG. 2B is an enlarged view illustrating the inspection device of FIG. 1.

Referring to FIGS. 1, 2A, and 2B, the terahertz signal-based inspection device 100 (hereinafter, referred to as “inspection device”) may include a light source 10, a first optical array 30, a second optical array 40, a stage 80, and a controller 70.

The light source 10 may generate and output a laser beam with very short pulses. For example, the light source 10 may generate and output a femtosecond laser beam L. In one or more embodiments, the femtosecond laser beam L may have a pulse width from about 10 fs to about 200 fs. However, the pulse width of the femtosecond laser beam L should not be limited thereto or thereby.

The femtosecond laser beam L may have a near infrared ray (NIR) wavelength. In the inspection device 100 according to one or more embodiments, the femtosecond laser beam L generated by the light source 10 may have a wavelength equal to or greater than about 1000 nm. In more detail, the femtosecond laser beam L may have a wavelength from about 1000 nm to about 1600 nm.

A beam splitter 20 may be provided on a path through which the femtosecond laser beam L output from the light source 10 travels. The beam splitter 20 may split a light generated by the light source 10, i.e., the femtosecond laser beam L, and may provide the split light to the first optical array 30 and the second optical array 40. To this end, the beam splitter 20 may be disposed between the light source 10 and the first optical array 30 and between the light source 10 and the second optical array 40.

The beam splitter 20 may be a half mirror. The beam splitter 20 may transmit a portion of the femtosecond laser beam L and may reflect the other portion of the femtosecond laser beam L. That is, the beam splitter 20 may split the femtosecond laser beam L into a first light L1 and a second light L2 depending on whether the femtosecond laser beam L is transmitted or reflected. When the reflected femtosecond laser beam L is referred to as the first light L1 and the transmitted femtosecond laser beam L is referred to as the second light L2, the first light L1 may travel to the first optical array 30, and the second light L2 may travel to the second optical array 40.

The first optical array 30 may be a THz optical array and may correspond to a THz radiator for THz time-domain spectroscopy (THz-TDs). The first optical array 30 may include a first delay element 31 and a light modulator 33.

The first delay element 31 may delay and control time at which the first light L1, which is incident into the first optical array 30, is input to the light modulator 33. To this end, the first delay element 31 may be implemented to change a length of optical path for the first light L1.

The first delay element 31 may include a plurality of mirrors. In one or more embodiments, the first delay element 31 may include first, second, and third optical mirrors sequentially arranged along the optical path. As indicated by a left-right arrow in FIG. 2B, the first delay element 31 may linearly move one of the first to third optical mirrors, e.g., the second optical mirror, to control the delay time of the first light L1. In one or more embodiments, the first delay element 31 may change the length of optical path of the first light L1 by varying a distance between the optical mirrors, however, the present disclosure should not be limited thereto or thereby. According to one or more embodiments, the first delay element 31 may also change the length of optical path of the first light L1 by switching optical fibers of different lengths using an optical switch.

The first light L1 may travel to the light modulator 33 via the first delay element 31.

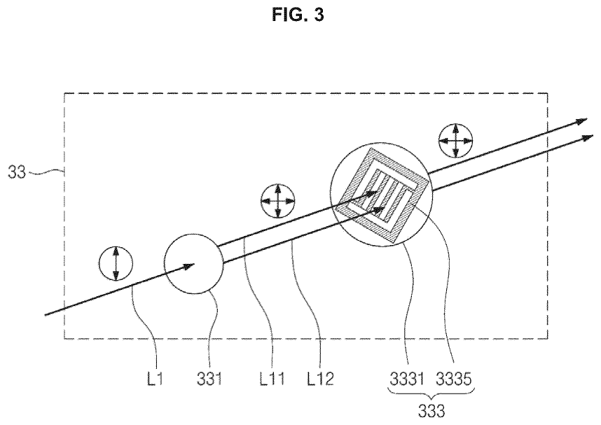

FIG. 3 is a conceptual view illustrating the light modulator 33 according to one or more embodiments of the present disclosure.

Referring to FIG. 3, the light modulator 33 may include a wave plate 331 and a first amplitude modulator 333.

The wave plate 331 may change a polarization state of a first light L1. According to one or more embodiments, the wave plate 331 may split the first light L1 into a first sub-light L11 that is vertically polarized and a second sub-light L12 that is horizontally polarized. In the present disclosure, the first sub-light L1 and a second sub-light L2 travel along substantially the same path with only their polarization directions being perpendicular to each other. However, for the sake of convenience in explanation, the first light L1 and the second light L2 are illustrated as separate lights in FIG. 3.

The wave plate 331 may be a quarter wave plate (QWP, a λ/4 wave plate) or a half wave plate (HWP, a λ/2 wave plate). In general, the femtosecond laser beam emitted from the light source 10 may be horizontally polarized, and the femtosecond laser beam may be circularly polarized or linearly polarized in horizontal and vertical directions by the quarter wave plate (QWP, λ/4 wave plate) or the half wave plate (HWP, λ/2 wave plate). The polarized first sub-light L11 and the polarized second sub-light L12 may be polarized in different directions but they may still have wavelengths within an NIR wavelength range.

The first amplitude modulator 333 may modulate each of the first sub-light L11 and the second sub-light L12 into a terahertz light.

The first amplitude modulator 333 may include an antenna 3331 that receives the first light L1 and generates the terahertz light and a rotating mount 3335 that transmits a rotational force to allow the antenna 3331 mounted thereon to be rotated.

The antenna 3331 may change an amplitude of the first sub-light L11 and the second sub-light L12 to modulate each of the first sub-light L11 and the second sub-light L12 into the terahertz light. That is, the antenna 3331 may receive the first sub-light L11 and the second sub-light L12, may convert the first sub-light L11 and the second sub-light L12 into a photocurrent, and may generate the photocurrent as the first sub-light L11 and the second sub-light L12, each having a terahertz wavelength.

The antenna 3331 may be provided on the rotating mount 3335. The rotating mount 3335 may rotate a direction of an electrode of the antenna 3331 by a predetermined angle to allow the first light L1, i.e., the first sub-light L11 and the second sub-light L12, to be circularly polarized. As an example, the rotating mount 3335 may rotate the antenna 3331 so that the direction of the electrode of the antenna 3331 is offset by about 45° with respect to a vibration axis of the first light L1.

According to one or more embodiments, the antenna 3331 may generate the first and second sub-lights L11 and L12 of terahertz waves, where only the polarization direction differs, while all other characteristics of the first and second sub-lights L11 an L12 are substantially the same.

Referring to FIGS. 1, 2A, and 2B again, the first optical array 30 may further include various components to optimize characteristics and paths of light traveling to an inspection target TG. In one or more embodiments, the first optical array 30 may further include various lenses and mirrors such as an off-axis parabolic mirror 35, a THz wave lens or reflective objective lens 39, a reflective mirror 37, etc. The off-axis parabolic mirror 35 may cause the first and second sub-lights L11 and L12 to rotate by about 90°. The reflective objective lens 39 may be a low numerical aperture reflective objective lens.

The first sub-light L11 and the second sub-light L12 may be provided to the inspection target TG via the first optical array 30.

The second optical array 40 may be a pump optical array. The second optical array 40 may include a second delay element 41 and a second harmonic generator 45 (“SHG”).

The second delay element 41 may perform substantially the same function as the first delay element 31. As an example, the second delay element 41 may delay and control time at which the second light L2 is input to the harmonic generator 45. The second delay element 41 may include first, second, and third optical mirrors sequentially arranged along the optical path. As indicated by a left-right arrow in FIG. 2B, the second delay element 41 may linearly move one of the first to third optical mirrors, e.g., the second optical mirror, to control the delay time of the second light L2.

The harmonic generator 45 may be configured to allow the second light L2 split by the beam splitter 20 to be incident on a microprobe 50. The second harmonic generator 45 may convert a wavelength of the second light L2 to increase a detection sensitivity of the microprobe 50 by efficiently generating optical carriers in the microprobe 50 described later. The harmonic generator 45 may include a focusing lens 45a, a nonlinear optical material 45b, and a sighting lens 45c, which are sequentially arranged. The focusing lens 45a may condense the second light L2 to the nonlinear optical material 45b. The nonlinear optical material 45b may convert the second light L2, incident on the harmonic generator 45, into a light with half the wavelength of the second light L2. For the nonlinear optical material 45b, for example, a nonlinear optical crystal such as a BBO or LBO crystal may be used. The light exiting from the nonlinear optical material 45b may travel to a probe focusing lens 47 after passing through the sighting lens 45c.

The second optical array 40 may include a beam shutter that physically blocks the light travelling thereto from the beam splitter 20. The beam shutter may physically block the second light L2 from the beam splitter 20. In other words, when the beam shutter blocks the second light L2, the second optical array 40 does not operate, and when the beam shutter transmits the second light L2, the second optical array 40 may operate. The second optical array 40 may further include various components, e.g., various focusing lenses like the probe focusing lens 47 and mirrors including the flat mirrors 43a and 43b, to optimize the characteristics and the path of the light traveling to the inspection target TG. The second light L2 exiting from the second optical array 40 may be provided to the microprobe 50.

The inspection device 100 may inspect the inspection target TG in a non-contact and non-destructive manner. Various semiconductor devices, e.g., a wafer, may be used as the inspection target TG. The wafer may include silicon (Si). The wafer may include a semiconductor element, such as germanium (Ge), or a compound semiconductor, such as silicon carbide (SIC), gallium arsenide (GaAs), indium arsenide (InAs), and indium phosphide (InP). According to one or more embodiments, the wafer may have a silicon-on-insulator (SOI) structure. The wafer may include a buried oxide layer. According to one or more embodiments, the wafer may include a conductive region, e.g., wells doped with impurities. According to one or more embodiments, the wafer may have various device isolation structures, such as a shallow trench isolation (STI) structure, which separate the doped wells from each other.

The wafer may be one on which a series of processes are performed. The series of processes may include various processes to form the semiconductor device. The series of processes may include, for example, an ion doping process, an oxidation process to form an oxide film, a lithography process including spin coating, exposure and development, a thin film deposition process including chemical vapor deposition (CVD), atomic layer deposition (ALD), and physical vapor deposition (PVD), a dry etching process, a wet etching process, and a metal wiring process.

In one or more embodiments, the wafer may include at least a portion or all of the semiconductor device formed thereon and may include individually packaged semiconductor devices. The semiconductor devices may include transistors, integrated circuits, resistors, capacitors, etc. As an example, according to the present disclosure, a MOSFET among the semiconductor devices, in particular, a channel of the MOSFET, may be provided as the inspection target TG. In addition, a test device inspected by the inspection device 100 may be an electronic device that utilizes the photoelectric effect of a semiconductor, such as a photodiode, an image sensor such as a CMOS sensor or a CCD sensor, a solar cell, or an LED.

Hereinafter, the wafer will be described as the inspection target TG.

The inspection device 100 may provide a pulse signal having a predetermined frequency band within a terahertz range, for example, from about 0.1 THz to about 10 THz, to the wafer and then may detect a frequency-intensity distribution of the pulse signal transmitted through or reflected from the wafer to inspect the wafer. Various information such as a wafer structure, a wafer doping concentration, and a carrier movement may be obtained from the inspection results by the inspection device 100.

The stage 80 may include a wafer chuck. The wafer that is the inspection target TG may be placed on the wafer chuck. The wafer chuck may be, for example, a three-point wafer chuck.

According to one or more embodiments, the light provided from the first optical array 30 may be incident on the wafer that is the inspection target TG after passing through the stage 80. The light passing through the inspection target TG may be detected by the microprobe 50.

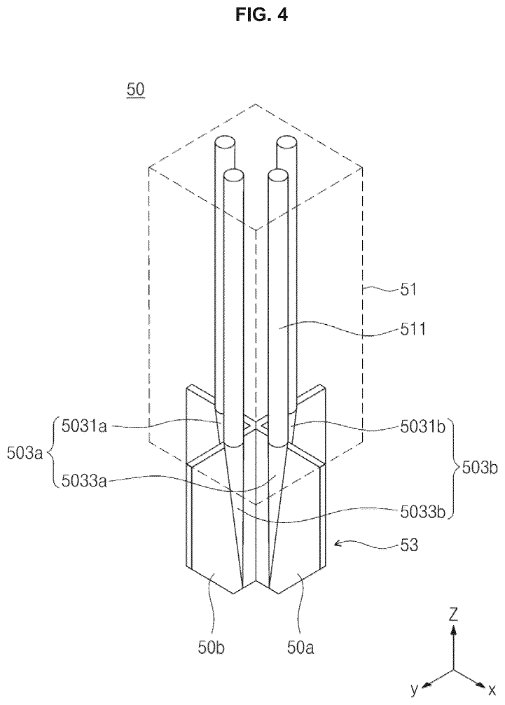

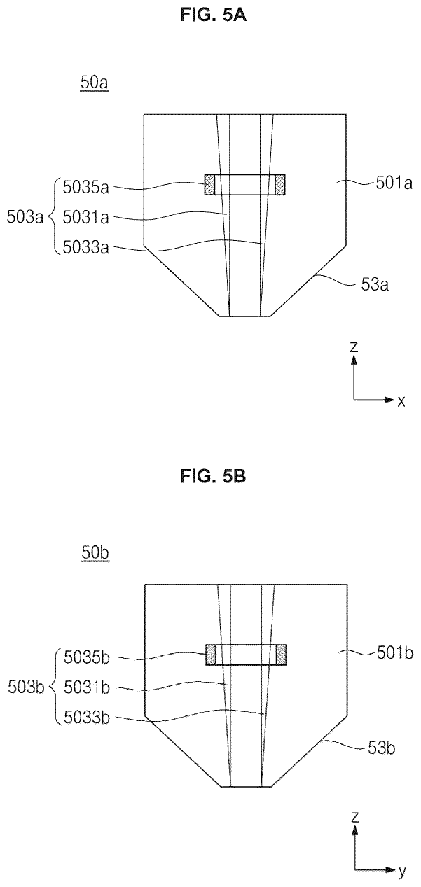

FIG. 4 is a perspective view illustrating the microprobe 50 according to one or more embodiments of the present disclosure. FIGS. 5A and 5B are plan views illustrating probe tips of first and second microprobes 50a and 50b, respectively.

Referring to FIGS. 4, 5A, and 5B, the microprobe 50 may include the first microprobe 50a to detect the first sub-light L11 and the second microprobe 50b to detect the second sub-light L12.

The first microprobe 50a and the second microprobe 50b may include two probe tips 53. The probe tips 53 may be connected to a probe body 51. The probe body 51 may hold the probe tips 53, may mechanically support the probe tips 53, and may provide an electronic path, e.g., signal lines 511, to read a signal detected by a receiver described later.

The two probe tips 53 may include a first probe tip 53a and a second probe tip 53b.

The first probe tip 53a may include a first probe substrate 501a and a first receiver 503a provided on the first probe substrate 501a, and the second probe tip 53b may include a second probe substrate 501b and a second receiver 503b provided on the second probe substrate 501b. Each of the first receiver 503a and the second receiver 503b may be provided as a photodetector including a photodiode.

The first probe substrate 501a and the second probe substrate 501b may be, for example, a low-temperature grown-gallium arsenide (LT-GaAs) or low-temperature grown-indium gallium arsenide (LT-InGaAs) substrate. However, the materials for the probe substrate are not limited thereto.

Each of the first probe substrate 501a and the second probe substrate 501b may have a flat shape extending in a specific direction. Each of the first probe substrate 501a and the second probe substrate 501b may have the flat shape substantially parallel to the direction in which the first light L1, i.e., the first sub-light L11 and the second sub-light L12, is polarized.

When three axes perpendicular to each other are referred to as an x-axis, a y-axis, a z-axis, respectively, directions in which the x-axis, the y-axis, and the z-axis extend are referred to as an x-direction, a y-direction, and a z-direction, respectively, and the first light L1 travels in the z-direction, each of the first probe substrate 501a and the second probe substrate 501b may extend in the z-direction. The first probe substrate 501a and the second probe substrate 501b may have a tapered shape at a lower portion thereof. In one or more embodiments, an upper portion of the probe tip 53 may mean a portion that is connected to the probe body 51, and the lower portion of the probe tip 53 may mean a portion opposite to the upper portion of the probe tip 53.

According to one or more embodiments, the first probe substrate 501a and the second probe substrate 501b may intersect with each other in a direction perpendicular to the extension direction thereof. When looking at the first probe substrate 501a and the second probe substrate 501b in the z-axis direction, the first probe substrate 501a and the second probe substrate 501b may be vertically intersect with each other to form a cross-shaped structure. As an example, the first probe substrate 501a may have the flat shape substantially parallel to a plane defined by the x-axis and the z-axis, and the second probe substrate 501b may have the flat shape substantially parallel to a plane defined by the y-axis and the z-axis. The intersection of the first probe substrate 501a and the second probe substrate 501b is to detect the first sub-light L11 and the second sub-light L12, which intersect perpendicularly to each other.

The first receiver 503a may include first and second electrodes 5031a and 5033a and a first photoconductive switch 5035a connected to the first and second electrodes 5031a and 5033a. The first photoconductive switch 5035a may generate photo-excited carriers in response to the second light L2. Accordingly, the first photoconductive switch 5035a may generate a photoelectric signal in response to a light polarized in the specific direction of the first light L1 reaching the first probe tip 53a, for example, one of the first sub-light L11 and the second sub-light L12. In one or more embodiments, the first photoconductive switch 5035a may generate a first photoelectric signal in response to the first sub-light L11.

Similar to the first receiver 503a, the second receiver 503b may include first and second electrodes 5031b and 5033b and a second photoconductive switch 5035b connected to the first and second electrodes 5031b and 5033b.

The second photoconductive switch 5035b may generate photo-excited carriers in response to the second light L2. Accordingly, the second photoconductive switch 5035b may generate a photoelectric signal in response to a light polarized in the specific direction of the second sub-light L2 reaching the second probe tip 53b, for example, the other of the first sub-light L11 and the second sub-light L12. In one or more embodiments, the second photoconductive switch 5035b may generate a second photoelectric signal in response to the second sub-light L12.

The first probe substrate 501a and the second probe substrate 501b may be arranged to intersect each other. As an example, when the first electrode 5031a and the second electrode 5033a of the first microprobe 50a are arranged in a first direction and the first electrode 5031b and the second electrode 5033b of the second microprobe 50b are arranged in a second direction, the first direction may intersect the second direction. According to the present disclosure, the first direction and the second direction may be perpendicular to each other. In detail, the first electrode 5031a and the second electrode 5033a of the first microprobe 50a may be arranged in the x-axis direction on the first probe substrate 501a. The first electrode 5031b and the second electrode 5033b of the second microprobe 50b may be arranged in the y-axis direction on the second probe substrate 501b. Accordingly, the first and second electrodes 5031a and 5033a of the first microprobe 50a and the first and second electrodes 5031b and 5033b of the second microprobe 50b may intersect with each other. In one or more embodiments, the first and second electrodes 5031a and 5033a of the first microprobes 50a may be arranged corresponding to the polarization direction of the first sub-light L11, and the first and second electrodes 5031b and 5033b of the second microprobes 50b may be arranged corresponding to the polarization direction of the second sub-light L12.

The first microprobe 50a and the second microprobe 50b are arranged to intersect each other, allowing them to individually receive the light polarized in the specific direction, i.e., the directions that intersect with each other. As an example, the first microprobe 50a may receive the first sub-light L11 vertically polarized, and the second microprobe 50b may receive the second sub-light L12 horizontally polarized.

The first microprobe 50a and the second microprobe 50b may be aligned to an inspection position based on the photoelectric signal generated by the first photoconductive switch 5035a. To this end, the inspection device 100 may include an alignment device to align the first microprobe 50a and the second microprobe 50b to the inspection position. The alignment device may move the first and second microprobes 50a and 50b to positions appropriate to inspect the wafer. The alignment device may move the first and second probe tips 53a and 53b to allow the first microprobe 50a and the second microprobe 50b to detect the terahertz wave passing through the wafer. The alignment device may move the first and second probe tips 53a and 53b so that the first and second probe tips 53a and 53b are located at spatial maxima of the terahertz wave in an x-y plane. The alignment device may move the first and second probe tips 53a and 53b vertically, for example, in the z-direction, so that the first and second probe tips 53a and 53b may be spaced vertically from an upper surface of the wafer, i.e., in the z-direction, by a distance appropriate to inspect the wafer, for example, several tens of micrometers. According to embodiments, when the positions of the first photoconductive switch 5035a and the second photoconductive switch 5035b are arranged on the path of the first light L1, the photoelectric signal generated by the first and second photoconductive switches 5035a and 5035b may be maximized. When the positions of the first and second microprobes 50a and 50b are adjusted to maximize the photoelectric signal generated by the first and second photoconductive switches 5035a and 5035b, the positions of the first and second receivers 503a and 503b included in the first probe tip 53a and the second probe tip 53b may be precisely aligned.

A signal analyzer 71 may analyze signals detected by the first and second microprobes 50a and 50b.

The controller 70 may be configured by a general computer equipped with a CPU, a ROM, and a RAM, etc., and may control the components of a detection device.

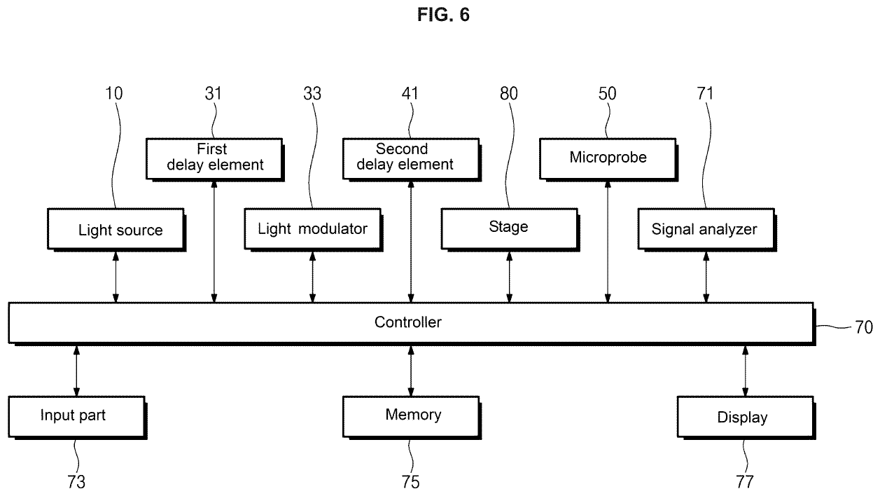

FIG. 6 is a block diagram illustrating a connection relationship between the controller 70 and other components in the detection device according to one or more embodiments of the present disclosure.

Referring to FIG. 6, the controller 70 may control the light source 10, the first optical array 30, the second optical array 40, the stage 80, etc. As an example, the controller 70 may be connected to the first delay element 31 and the light modulator 33 of the first optical array 30, the second delay element 41 of the second optical array 40, the stage 80, the microprobe 50, and the signal analyzer 71 in addition to the light source 10, and may control the operation of each component or transmit and receive data to and from each component. As an example, the controller 70 may control on/off of the light source 10. The controller 70 may control the amount of optical delay by the first delay element 31 and/or the second delay element 41.

The controller 70 may control the polarization direction, the polarization degree, and the modulated wavelength range with respect to the light modulator 33. The controller 70 may change the position of the stage 80 for the measurement. The controller 70 may determine whether the first and second microprobes 50a and 50b of the microprobe 50 detect the first sub-light and/or the second sub-light. In addition, the controller 70 may determine whether the detected first sub-light and/or second sub-light are analyzed or may transmit and receive data about the analysis results. In addition, the controller 70 may perform functions such as generating various images to analyze signals, restoring or interpreting time waveforms, etc., and these functions may be implemented by the CPU included in the controller 70. However, the functions may be implemented in hardware in a separate dedicated circuit other than the CPU of the controller 70.

A memory 75 where various data are stored may be connected to the controller 70. The memory 75 may include a fixed disk, such as a hard disk, as well as a portable media. The controller 70 may have access to the memory 75 through a network line. The controller 70 may include an input part 73 to enter user-specified operating conditions and information required for the inspection and a display 77 to display various information. The input part 73 may include various input devices such as a mouse, a keyboard, etc. The user may perform a specified operation input through the input part 73. In addition, when the display 77 is provided as a touch panel, the display 77 may function as the input part 73. The display 77 may also display a graphical user interface (GUI) screen thereon, which is required to set inspection conditions. As an example, the inspection conditions may include an inspection range, the positions of the first and second delay elements 31 and 41, etc. The controller 70 may further include additional components such as a camera, which is used to specify an irradiation position of the second light.

The controller 70 may be implemented as a digital signal processor (DSP) processing digital signals, a microprocessor, or a time controller (TCON). However, the disclosure is not limited thereto, and the controller 70 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the controller 70 may be implemented as a system on chip (SoC) having a processing algorithm stored therein or large scale integration (LSI), or in the form of a field programmable gate array (FPGA). The controller 70 may perform various functions by executing computer executable instructions stored in the memory 75. The controller may be implemented as one, or more than one processor.

According to one or more embodiments, the inspection device having the above-described structure may easily inspect the wafer in the non-destructive manner.

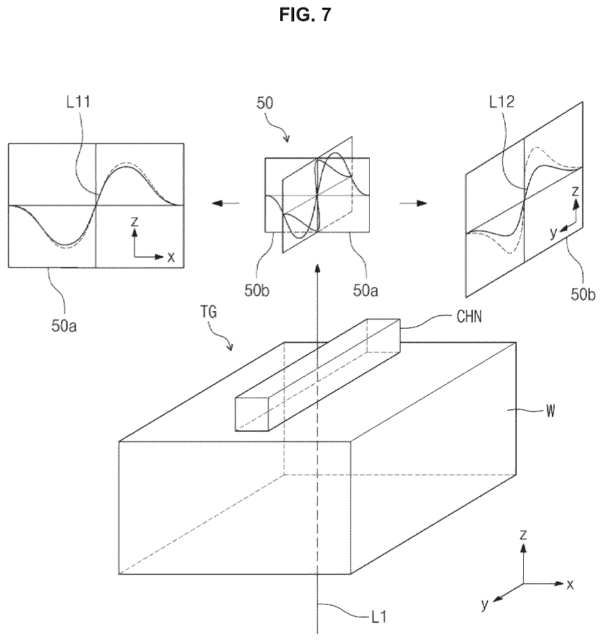

FIG. 7 is a view schematically illustrating a principle of the wafer inspection using the inspection device according to one or more embodiments of the present disclosure. FIG. 7 illustrates a wafer W that has undergone a predetermined process as an inspection target. FIG. 7 illustrates that a channel CHN having an anisotropic shape is formed as a part of a semiconductor element on the wafer W. The channel CHN may be used as a channel of the MOSFET and may be doped with impurities at a certain concentration. In particular, the channel CHN in FIG. 7 may have the anisotropic shape with a rectangular parallelepiped shape elongated in one direction, and the channel CHN may be elongated in the y-axis direction longer than in the x-axis direction. That is, the channel CHN may have a larger width in the y-axis direction than in the x-axis direction.

Referring to FIG. 7, a front surface and a rear surface of the wafer W may be substantially parallel to the x-y plane, and the first light L1 may transmit along a direction from the rear surface of the wafer W to the front surface of the wafer W. As described above, the first light L1 may include the first sub-light L11 vertically polarized and the second sub-light L12 horizontally polarized.

The microprobe 50 may include the first microprobe 50a and the second microprobe 50b to detect the first sub-light L11 and the second sub-light L12. In one or more embodiments, for the convenience of explanation, the first microprobe 50a may extend in the x-axis direction, and the second microprobe 50b may extend in the y-axis direction.

According to the present disclosure, the pulse of the first sub-light L11 and the pulse of the second sub-light L12 may temporally and/or spatially overlap each other and may be provided to the wafer W. When the channel CHN is formed on the wafer W, the channel CHN may absorb some wavelengths of the first light L1 that passes through the channel CHN. When the channel CHN has the anisotropic shape as described above, the first light L1 may be absorbed to different degrees for different linearly polarization components. That is, since the channel CHN has different shapes along the horizontal and vertical axes, the vertically polarized first sub-light L11 and the horizontally polarized second sub-light L12 may be absorbed by the channel CHN to different degrees. In other words, when the light passing through the channel CHN is polarized in the horizontal direction and the vertical direction, the light polarized in the horizontal direction and the light polarized in the vertical direction may transmit through the channel CHN to different degrees.

As an example, when assuming that the first sub-light L11 is linearly polarized in the x-axis direction and the second sub-light L12 is linearly polarized in the y-axis direction, the first sub-light L11 may be absorbed to a certain extent by the channel CHN. The second sub-light L12 may be absorbed to a certain extent by the channel. The second sub-light may be absorbed by the channel to a greater extent than the first sub-light L11.

The first microprobe 50a and the second microprobe 50b may respectively detect the first sub-light L11 and the second sub-light L12 after the first and second sub-lights L11 and L12 have passed through the wafer W and the channel CHN.

The first sub-light L11 and second sub-light L12 detected by the first microprobe 50a and the second microprobe 50b are respectively illustrated in the form of waveforms in FIG. 7. In FIG. 7, the light that is detected by the first microprobe 50a and the second microprobe 50b when the channel CHN does not absorb the light is represented by a dotted line, and the light that is detected by the first microprobe 50a and the second microprobe 50b when the channel CHN absorbs the light is represented by a solid line.

As shown in FIG. 7, the first and second microprobes 50a and 50b may detect different degrees of light depending on the anisotropy of the channel CHN. According to one or more embodiments, the first and second microprobes 50a and 50b may detect different degrees of light depending on the polarization direction of the first sub-light L11 and the second sub-light L12. In one or more embodiments, due to the anisotropic absorption of the light by the channel CHN, a reduction amount of the second sub-light L12 may be greater than that of the first sub-light L11, and the first and second microprobes 50a and 50b may detect the first sub-light L11 with a value greater than the second sub-light L12.

According to the present disclosure, as the absorption degree of the first sub-light L11 and the second sub-light L12 are simultaneously measured and the first sub-light L11 and the second sub-light L12 are compared to each other based on the measured values, the anisotropy in the specific direction of the channel CHN may be inversely inferred.

According to one or more embodiments, since the microprobe 50 includes both the first microprobe 50a and the second microprobe 50b intersecting the first microprobe 50a, the microprobe 50 may substantially simultaneously detect the vertically polarized light and the horizontally polarized light.

When the structures on the wafer W are commonly or symmetrically provided with respect to the path of the first light L1, even though the first light L1 transmits through the structures, the signal detected by the first microprobe 50a and the signal detected by the second microprobe 50b may be substantially identical. Accordingly, the signals detected by the first and second microprobes 50a and 50b may be easily excluded in the signal analysis stage, and it is easy to obtain the differences caused only by the shape and/or physical properties of the anisotropic channel CHN. As an example, when comparing the horizontally polarized second sub-light L12 detected by the second microprobe 50b with the vertically polarized first sub-light L11 detected by the first microprobe 50a, the signals absorbed by structures unrelated to the channel CHN may cancel each other out and disappear.

According to a comparative example of a channel inspection device with only one microprobe, a light transmitted through a wafer and a channel may be measured with one microprobe. However, since there is only one microprobe, only a light that is linearly polarized to align with a direction of a probe tip's plane among the light transmitted through the wafer and the channel may be effectively measured. Accordingly, the evaluation of the channel is possible only in one direction, and additional inspections are required to be performed at least once for the evaluation of the channel in other directions. Further, to minimize differences in signals caused by absorption in a commonly placed lower layer, the inspection is required both before and after formation of the lower layer. These additional inspections increase complexity of processes and increase time and cost of the processes. In addition, when the channel inspection for different directions is repeated with the same protocol, the conditions may not be exactly the same as those of the initial channel inspection for the one direction. Accordingly, it is impossible to accurately obtain the differences caused by the shape and/or physical properties of the wafer and channel.

In comparison, the inspection device according to the present disclosure may substantially simultaneously measure the horizontally polarized first sub-light L11 and the vertically polarized second sub-light L12 using the first and second microprobes 50a and 50b that intersect each other, and thus, the difference caused by the shape and/or physical properties of the wafer W and the channel CHN may be accurately obtained under the same conditions.

In more detail, since the channel CHN of the transistors with the MOSFET structure may have the anisotropic shape in the x-y plane, the channel CHN may have a bar shape that extends longer in one direction as described above. Accordingly, the structure and/or physical properties of the channel CHN may be easily identified by transmitting the terahertz waves with the polarization components that intersect each other after the process of forming the MOSFET structure using the structural characteristics of the channel CHN. The inspection device may utilize the fact that, when the channel CHN has the anisotropic shape as described above, the absorption of the terahertz waves corresponding to a length direction of the channel CHN are highly absorbed while the absorption of the terahertz waves corresponding to a width direction of the channel CHN are small. Therefore, it is possible to extract only the signal related to electrical property state of the channel CHN in the MOSFET by simultaneously measuring the terahertz waves of two linearly polarized lights intersecting each other and using the ratio of the measured two signals. This allows the exclusion of the influence on signals caused by the lower layer other than the MOSFET structure with just a single measurement.

In the present disclosure, the channel is described as the inspection target, however, the inspection target should not be limited thereto or thereby. The inspection device according to the present disclosure may inspect various targets such as a thickness of the channel, a degree of impurities doped in the channel, a thickness of an insulating layer, a thickness of a depletion layer, an internal deformation of the channel, and activation after annealing of the channel.

In the case of semiconductor devices, development is being conducted on controlling physical properties, such as developing three-dimensional structures, introducing new materials of High-K/Low-K, and improving electron mobility through intentional deformation, to miniaturize circuit patterns. For this purpose, high-precision and high-throughput property measurements are very necessary for both process establishment in R&D and yield improvement in mass production. As an example, it is necessary to measure an amount or spatial distribution of dopants and a reactivation state after annealing in an ion implantation process or to measure an amount of internal deformation in a selective epitaxial growth process of SiGe. These measurements are performed using physical inspection devices such as an optical critical dimension (OCD) or using chemical measurement methods using fluorescence X-ray or mass spectrometry. The measurement methods described above are precise but face challenges in handling large volumes, leading to frequent destructive testing. According to the present disclosure, the inspection on the inspection target TG is performed in a non-destructive manner using the THz time domain spectroscopy technology, and thus, it is possible to perform a large number of inspections without destroying the semiconductor devices.

Although the embodiments of the present disclosure have been described, it is understood that the present disclosure should not be limited to these embodiments but various changes and modifications can be made by one ordinary skilled in the art within the spirit and scope of the present disclosure as hereinafter claimed.

Therefore, the disclosed subject matter should not be limited to any single embodiment described herein, and the scope of the present disclosure shall be determined according to the attached claims.

What is claimed is:

1. An inspection device comprising:
a light source generating and outputting a femtosecond laser beam;
a beam splitter configured to split the femtosecond laser beam into a first light and a second light;
a first optical array configured to separate the first light into a first sub-light and a second sub-light and to provide the first and the second sub-lights to an inspection target, wherein the first sub-light and the second sub-light are polarized in different directions;
a microprobe configured to detect a photoelectric signal caused by incidence of the first and the second sub-lights on the inspection target, the microprobe comprising a first microprobe configured to detect the first sub-light and a second microprobe configured to detect the second sub-light; and
a second optical array configured to provide the second light to the microprobe.

2. The inspection device of claim 1, wherein the first sub-light comprises a vertically polarized terahertz light, and the second sub-light comprises a horizontally polarized terahertz light.

3. The inspection device of claim 2, wherein the first optical array comprises:
a wave plate configured to polarize the first light; and
a first amplitude modulator configured to modulate a wavelength of the first light.

4. The inspection device of claim 3, wherein the wave plate is configured to polarize the first light into the first sub-light and the second sub-light.

5. The inspection device of claim 4, wherein the wave plate comprises a quarter wave plate or a half wave plate.

6. The inspection device of claim 3,
wherein the first amplitude modulator comprises:
an antenna configured to modulate an amplitude of the first light to generate the vertically polarized terahertz light and the horizontally polarized terahertz light; and
a rotating mount configured to transmit a rotational force to the antenna, and
wherein the antenna is mounted on the rotating mount.

7. The inspection device of claim 6, wherein the rotating mount is configured to rotate the antenna so that a direction of an electrode of the antenna is offset by about 45° from a vibration axis of the first light.

8. The inspection device of claim 1,
wherein the first microprobe comprises a first probe substrate and a first receiver on the first probe substrate,
wherein the second microprobe comprises a second probe substrate and a second receiver on the second probe substrate, and
wherein each of the first and the second receivers comprises a photodetector comprising a photodiode.

9. The inspection device of claim 8,
wherein each of the first and the second probe substrates has a plate shape, and
wherein the first and the second probe substrates intersect each other.

10. The inspection device of claim 8,
wherein the first receiver comprises:
a first electrode and a second electrode each on the first probe substrate; and
a first photoconductive switch connected to the first and the second electrodes on the first probe substrate; and
wherein the second receiver comprises:
a first electrode and a second electrode each on the second probe substrate; and
a second photoconductive switch connected to the first and the second electrodes on the second probe substrate.

11. The inspection device of claim 10,
wherein the first and the second electrodes of the first receiver are arranged in an x-axis direction, and
wherein the first and the second electrodes of the second receiver are arranged in a y-axis direction.

12. The inspection device of claim 11,
wherein the first and the second electrodes of the first receiver are configured to detect one of the first and the second sub-lights, and
wherein the first and the second electrodes of the second receiver are configured to detect the other of the first and the second sub-lights.

13. The inspection device of claim 1, wherein the inspection target comprises a wafer or at least a portion of a semiconductor device formed on the wafer.

14. The inspection device of claim 13, wherein the inspection target comprises a channel of a MOSFET.

15. The inspection device of claim 1, wherein the first light travels to the microprobe after passing through the inspection target.

16. A microprobe for an inspection device, the microprobe comprising:
a first microprobe configured to detect vertically polarized terahertz light; and
a second microprobe configured to detect horizontally polarized terahertz light,
wherein the first microprobe and the second microprobe intersect with each other.

17. The microprobe of claim 16,
wherein the first microprobe comprises a first probe substrate and a first receiver on the first probe substrate,
wherein the second microprobe comprises a second probe substrate and a second receiver on the second probe substrate, and
wherein the first and the second receivers each comprise a photodetector comprising a photodiode.

18. The microprobe of claim 17,
wherein each of the first and the second probe substrates has a plate shape, and
wherein the first and the second probe substrates intersect each other.

19. The microprobe of claim 17,
wherein the first receiver comprises:
a first electrode and a second electrode each on the first probe substrate; and
a first photoconductive switch connected to the first and the second electrodes on the first probe substrate; and
wherein the second receiver comprises:
a first electrode and a second electrode each on the second probe substrate; and
a second photoconductive switch connected to the first and the second electrodes on the second probe substrate.

20. The microprobe of claim 19,
wherein the first and the second electrodes of the first receiver are arranged in an x-axis direction, and
wherein the first and the second electrodes of the second receiver are arranged in a y-axis direction.
